(19) United States
(12) Patent Application Publication
(10) Pub. No.: US 2008/0239111 A1
(43) Pub. Date: Oct. 2, 2008

(54) Method and appratus for dark current compensation of imaging sensors

(75) Inventor: Jutao Jiang, Boise, ID (US)

Correspondence Address: DICKSTEIN SHAPIRO LLP, 1825 EYE STREET, NW, WASHINGTON, DC, 20006, US

(73) Assignee: MICRON TECHNOLOGY, INC.

(21) Appl. No.: 11/727,345

(22) Filed: Mar. 26, 2007

(51) Int. Cl. H04N 9/64

(52) U.S. Cl. 348/243; 348/E09.037

(57) ABSTRACT

Disclosed embodiments provide methods and apparatuses for dark current compensation of imager pixels signals. A row-wise dark offset is calculated and then subtracted from the imaging pixel signals, a row-wise dark offset for at least one row being different from a row-wise dark offset for at least another row.

### FIELD OF THE INVENTION

The embodiments described herein relate generally to imaging devices and, more specifically, to a method and apparatus for dark current compensation of imaging sensors employed in such devices.

### BACKGROUND OF THE INVENTION

Solid state imaging devices, including charge coupled devices (CCD), complementary metal oxide semiconductor (CMOS) imaging devices, and others, have been used in photo imaging applications. A solid state imaging device circuit includes a focal plane array of pixel cells or pixels as an image sensor, each cell including a photosensor, which may be a photogate, photoconductor, a photodiode, or other photosensor having a doped region for accumulating photo-generated charge. For CMOS imaging devices, each pixel has a charge storage region, formed on or in the substrate, which is connected to the gate of an output transistor that is part of a readout circuit. The charge storage region may be constructed as a floating diffusion region. In some CMOS imaging devices, each pixel may further include at least one electronic device such as a transistor for transferring charge from the photosensor to the storage region and one device, also typically a transistor, for resetting the storage region to a predetermined charge level prior to charge transference.

In a CMOS imaging device, the active elements of a pixel perform the necessary functions of: (1) photon to charge conversion; (2) accumulation of image charge; (3) resetting the storage region to a known state; (4) transfer of charge to the storage region; (5) selection of a pixel for readout; and (6) output and amplification of a signal representing pixel charge. Photo charge may be amplified when it moves from the initial charge accumulation region to the storage region. The charge at the storage region is typically converted to a pixel output voltage by a source follower output transistor.

CMOS imaging devices of the type discussed above are generally known as discussed, for example, in U.S. Pat. No. 6,140,630, U.S. Pat. No. 6,376,868, U.S. Pat. No. 6,310,366, U.S. Pat. No. 6,326,652, U.S. Pat. No. 6,204,524, and U.S. Pat. No. 6,333,205, assigned to Micron Technology, Inc., which are hereby incorporated by reference in their entirety.

Ideally, the digital images created by CMOS imaging devices are exact duplications of the light image projected upon the imaging sensor. However, various noise sources can affect individual pixel outputs and thus distort the resulting digital image. Some noise sources may affect the entire sensor array, thereby requiring frame-wide correction of the pixel output from the array. One such corrective measure, dark current compensation, is the process in which the dark signal component (e.g., dark offset caused by dark current) is subtracted from the signal output of a pixel. Dark current compensation is important at high temperatures (e.g., greater than 50 degrees Celsius), because dark current increases exponentially with temperature. Additionally, since dark current increases over integration time, imaging devices with long integration times (e.g., greater than 200 ms) should undergo dark current compensation.

FIG. 1 shows an exemplary CMOS imaging sensor 100 with an area 10 of a pixel array which contains rows and columns of imaging pixels, areas 12 of a pixel array which contain rows and columns of barrier pixels which separate the imaging pixels from other pixels and circuits, areas 14 of a pixel array which contain rows and columns of optical black pixels, and areas 16 of a pixel array which contain rows and columns of tied pixels (pixels in which the photodiode is tied to a fixed voltage, as described in published U.S. patent application Ser. No. 11/066,781, filed Feb. 28, 2005, and having publication number 2006-0192864, which is incorporated herein by reference). The imaging sensor 100 array uses a red, green, blue (RGB) Bayer pattern color filter array (CFA) over the imaging pixels in area 10. Alternatively, another color filter pattern may be used or the color filter array may be omitted for a monochrome image sensor. In the embodiments described herein, the color filter array is a Bayer pattern array over the imaging pixels in area 10 forming four color channels, blue, greenblue (green pixels in the same row as blue pixels), greenred (green pixels in the same row as red pixels), and red.

Optical black pixels in area 14 and tied pixels in area 16 are arranged in dark rows 18. A dark row is one that is not exposed to light and can be covered by a light shield layer, such as, for example, a metal-3 metallization layer, a black color filter, etc. It should be appreciated that areas of optical black pixels 14 and areas of tied pixels 16 may be arranged in any pattern within the dark rows 18 and are not limited to the arrangement shown in FIG. 1. Additionally, tied pixels in area 16 may, but need not, be arranged in dark columns 19. Optical black pixels in area 14 have the same structure as the imaging pixels in area 10 except they are arranged in dark rows so that incident light will not affect their signal output. The photodiode within each tied pixel in area 16 is connected to a fixed voltage via a metal contact so that the signal of the tied pixel in area 16 is not affected by dark current.

FIG. 2 illustrates a dark current compensation method for an imaging sensor which is described in unpublished U.S. patent application Ser. No. 11/302,124, filed Dec. 14, 2005, and which is incorporated herein by reference. At step 1000, the signals from the optical black pixels in area 14 (FIG. 1) and the tied pixels in area 16 (FIG. 1) of the dark rows 18 (FIG. 1) are read out. (Dark columns 19 are not needed for this dark current compensation method.) A total dark offset, Dₜₒₜₐₗ, caused by dark current during an integration time (tᵢₙₜ_{_{—}}_{global}) is calculated (step 1010) based on the difference between the average of the optical black pixel signals in area 14 (OB_{avg}) and the average of the tied pixel signals in area 16 (T_{avg}) according to:

Dₜₒₜₐₗ=OB_{avg}−T_{avg} (1)

Next, the signals from the rows of imaging pixels in area 10 are read out (step 1020). Finally, the calculated dark offset, Dₜₒₜₐₗ, is subtracted from each imaging pixel in area 10 (step 1030). As shown in the flowchart of FIG. 2, by subtracting the calculated dark offset from the signal of each imaging pixel in area 10 (FIG. 1) of the imaging sensor 100 (FIG. 1), a frame-wide dark current compensation of imaging sensor 100 can be achieved.

In a CMOS pixel array, this method is sufficient when the internal time between pixel reset and signal sampling of a pixel is the same for all of the rows across the whole array of imaging pixels in area 10, such as, for example, when an imaging device operates in electronic rolling shutter (ERS) mode. However, for CMOS imaging sensors subject to a “global reset” shutter mode, such as, for example, imaging sensors designed for digital still cameras (DSC) or digital single-lens reflex (DSLR) cameras, this method is insufficient. In such cameras, the imaging device will operate in electronic rolling shutter mode during preview mode (e.g., viewing the scene on camera's liquid crystal display (LCD)) while the mechanical shutter stays open. However, when the shutter button is pressed to capture a still image, the imaging device will output the last electronic rolling shutter frame and enter a global reset mode. Then, all of the rows of pixels will be held at reset for a specific amount of time so that all of the array of pixels can be reset. Next, all of the rows of pixels will be released from reset simultaneously, causing all of the imaging pixels in the whole imaging sensor array to start integrating light simultaneously. At the end of the integration, a mechanical shutter will be closed and pixel signals will be read out row by row sequentially. The dark current compensation algorithm described above in relation to FIG. 2 is a “frame-wise” operation (i.e., it subtracts a constant dark offset for the whole array for each individual color pixel), so a vertical gradient will be observed for a global reset image because the rows read out later will integrate more dark current charge than the rows read out earlier. This vertical gradient might not be significant at room temperature and with low gain settings. However, the vertical gradient will be more pronounced at high temperatures, with higher gain settings (e.g., greater than 16), or simply in pixels with an inherent high dark current. Accordingly, an improved dark current compensation method is needed.

### BRIEF DESCRIPTION OF THE DRAWINGS

FIG. 1 illustrates a top view of a CMOS imaging sensor.

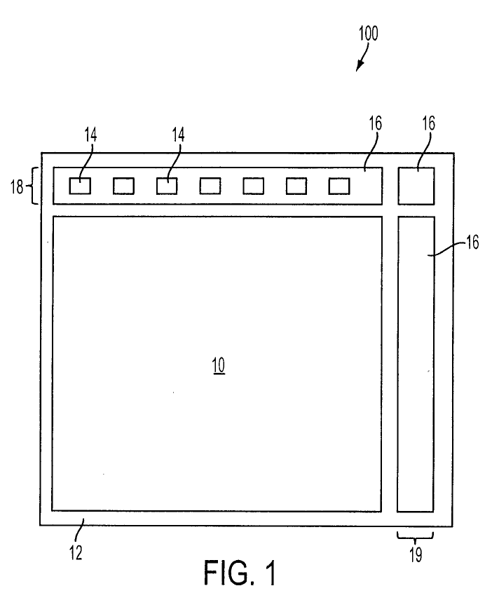

FIG. 2 illustrates a flowchart of a dark current compensation method.

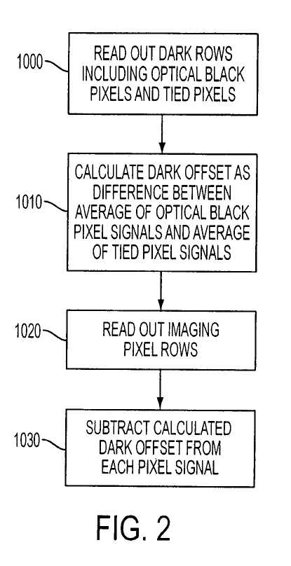

FIG. 3 illustrates a top view of a CMOS imaging sensor with dark rows located at the top of the imaging sensor.

FIG. 4 illustrates a flowchart of a method of dark current compensation based on dark rows located at the top of the imaging sensor.

FIG. 5 illustrates a top view of a CMOS imaging sensor with dark rows located at the bottom of the imaging sensor.

FIG. 6 illustrates a flowchart of a method of dark current compensation based on dark rows located at the bottom of the imaging sensor.

FIG. 7 illustrates a top view of a CMOS imaging sensor with dark columns.

FIG. 8A illustrates a flowchart of a method of dark current compensation based on dark columns.

FIG. 8B illustrates a flowchart of an additional method of dark current compensation based on dark columns.

FIG. 9A illustrates a block diagram of system-on-a-chip imaging device constructed in accordance with an embodiment.

FIG. 9B illustrates an example of a sensor core used in the FIG. 9A device.

FIG. 10 shows a system incorporating at least one imaging device.

### DETAILED DESCRIPTION OF THE INVENTION

In the following detailed description, reference is made to the accompanying drawings which form a part hereof, and in which is shown by way of illustration specific embodiments that may be practiced. These embodiments are described in sufficient detail to enable those of ordinary skill in the art to make and use them, and it is to be understood that structural, logical, or procedural changes may be made to the specific embodiments disclosed.

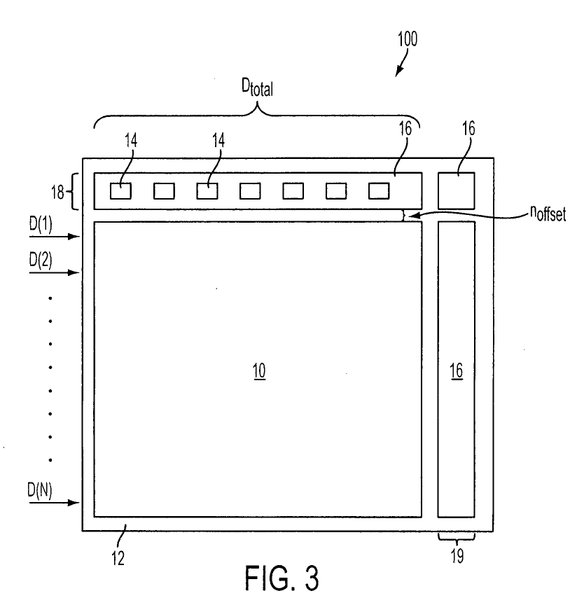

Embodiments of the invention provide row-wise dark current compensation to correct for dark current in an image captured using a global shutter mode. The read out time for each row of the pixel array can be expressed as:

$${t}_{row} = \frac{{t}_{int\_global}}{a} \qquad ( 2 )$$

where the integration time for global reset image capture is tᵢₙₜ_{_{—}}_{global} and “a” is a constant determined by the imaging sensor's design parameters, such as pixel clock rate, image size, horizontal blanking time in pixel clocks, or global reset operation register settings. As shown in FIG. 3, the signals of the dark row pixels 18 (comprised of optical black pixels in area 14 and tied pixels in area 16) will be read out first before the imaging pixels in area 10 readout. Although FIG. 3 shows the dark rows 18 as located on the top side of imaging area 10, the dark rows 18 can be placed in other locations, for example, the dark rows 18 could instead be located to the bottom of imaging area 10 or on both the top and bottom of imaging area 10. (Dark columns 19 are not needed for this dark current compensation embodiment.) After the readout of the dark rows 18, the dark offset (Dₜₒₜₐₗ) caused by dark current during the integration time (tᵢₙₜ_{_{—}}_{global}) can be derived based on the difference between the average of the optical black pixel signals in area 14 (OB_{avg}) and the average of the tied pixel signals in area 16 (T_{avg}) according to equation (1). Therefore, the dark offset caused by dark current during each row time t_{row} can be expressed as:

$${D}_{row} = \frac{{D}_{total}}{a} \qquad ( 3 )$$

The dark offset for each individual row can be calculated as follows:

D(n)=Dₜₒₜₐₗ+(n_{offset}+n)·D_{row} (4)

where n represents the row number (e.g., n=1, 2, . . . , N) of the imaging pixel array in area 10 and n_{offset} represents the number of rows between the last dark row 18 and the first row of the imaging pixel array in area 10. After readout of each row n in the imaging pixel array in area 10, a row number dependent dark offset value D(n) will be subtracted from each pixel output signal for that row.

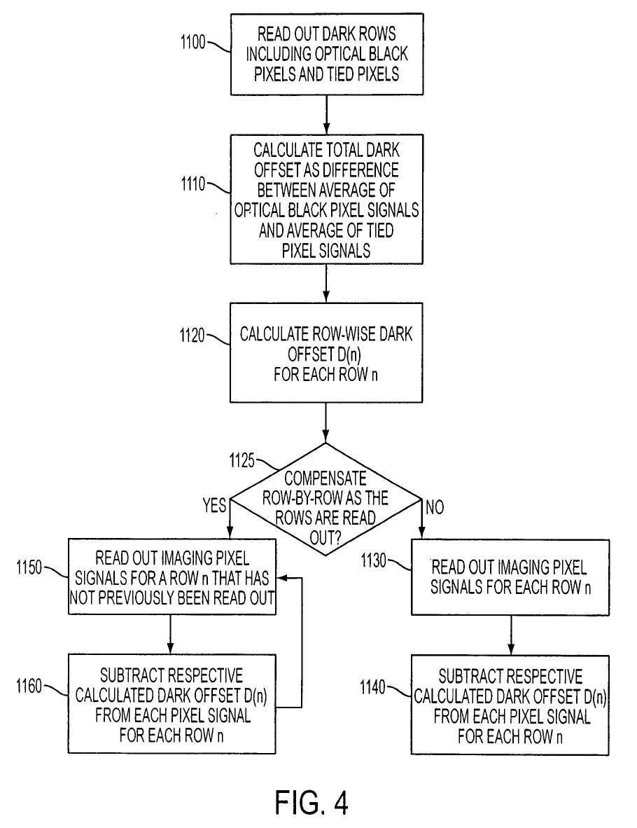

As shown in the flowchart of FIG. 4, by subtracting the respective calculated row-wise dark offset from each imaging pixel signal in area 10 (FIG. 3) of the imaging sensor 100 (FIG. 3), a frame wide dark current compensation of imaging sensor 100 can be achieved. At step 1100, the signals from the optical black pixels in area 14 (FIG. 3) and the tied pixels in area 16 (FIG. 3) of the dark rows 18 (FIG. 3) are read out. Then, the total dark offset is calculated (step 1110) as the signal difference obtained by a subtraction of the average of the tied pixels in area 16 from the average of the optical black pixels in area 14 using equation (1). Next, the row-wise dark offset D(n) is calculated for each row n using equation (4) (step 1120). If compensation is to be performed row-by-row as the rows are read out (step 1125), the signals from imaging pixels in area 10 are then read out for a row n (step 1150). The respective calculated row-wise dark offset for that row, D(n), is subtracted from the signals of each imaging pixel in row n of area 10 (step 1160). Steps 1150-1160 are repeated until all of the rows of area 10 have been read out and compensated. If compensation is to be performed after all of the imaging pixels in area 10 are read out (step 1125), the signals from the rows of imaging pixels in area 10 are read out for each row n (step 1130). The respective calculated dark offset D(n) is then subtracted from the signals of each imaging pixel in each row n in area 10 (step 1140).

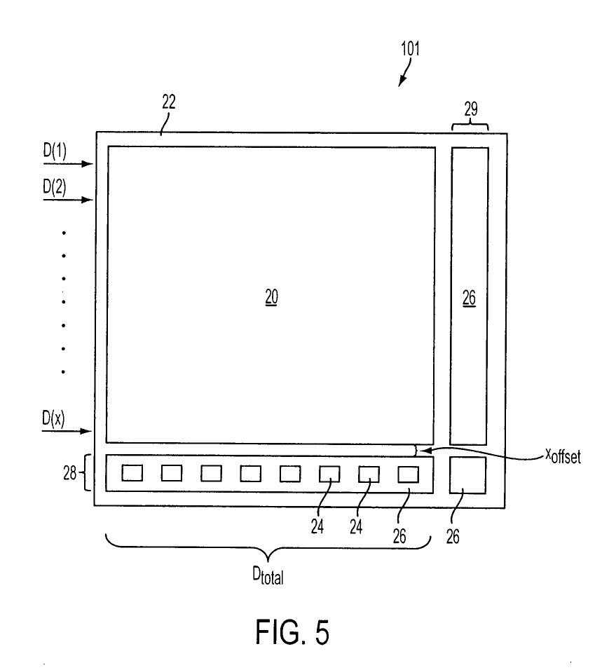

As an alternative embodiment, an imaging sensor may be constructed, as shown in FIG. 5, with dark rows 28 at the bottom of the imaging sensor 101. Each row x in the imaging pixel array in area 20 is read out. Then, the signals of the dark row pixels 28 (comprised of optical black pixels in area 24 and tied pixels in area 26) will be read out. Although FIG. 5 shows the dark rows 28 as located on the bottom side of imaging area 20, the dark rows 28 can be placed in other locations, for example, the dark rows 28 could instead be located to the top of imaging area 20 or on both the top and bottom of imaging area 20. (Dark columns 29 are not needed for this dark current compensation embodiment.) After the readout of the dark rows 28, the dark offset (Dₜₒₜₐₗ) caused by dark current during the integration time (tᵢₙₜ_{_{—}}_{global}) can be derived based on the difference between the average of the optical black pixel signals in area 24 (OB_{avg}) and the average of the tied pixel signals in area 26 (T_{avg}) according to equation (1). The dark offset caused by dark current during each row time t_{row} can be expressed according to:

$${D}_{row} = \frac{{D}_{total}}{a + {x}_{offset} + X} \qquad ( 5 )$$

The dark offset for each individual row can be calculated as follows:

D(x)=Dₜₒₜₐₗ−(x_{offset}+X−x+1)·D_{row} (6)

where x represents the row number (e.g., x=1, 2, . . . , X) of the imaging pixel array in area 20 and x_{offset} represents the number of rows between the last row of the imaging pixel array in area 20 and the first dark row. After readout of each row x in the imaging pixel array in area 20, a row number dependent dark offset value D(x) will be subtracted from each pixel output signal for that row.

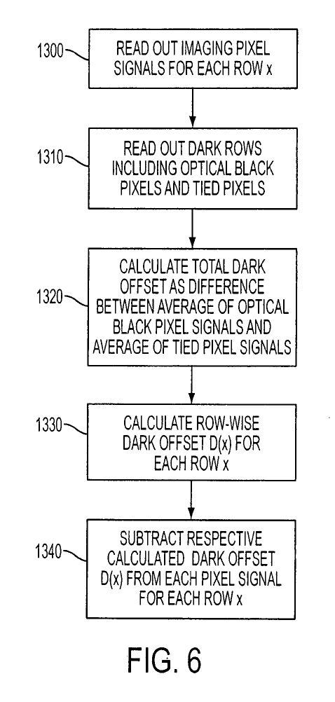

As shown in the flowchart of FIG. 6, by subtracting the respective calculated row-wise dark offset from each imaging pixel signal in area 20 (FIG. 5) of the imaging sensor 101 (FIG. 5), a frame wide dark current compensation of imaging sensor 101 can be achieved. At step 1300, the signals from the imaging pixels in area 20 (FIG. 5) are read out. Next, at step 1310, the optical black pixels in area 24 (FIG. 5) and the tied pixels in area 26 (FIG. 5) of the dark rows 28 (FIG. 5) are read out. Then, the total dark offset is calculated (step 1320) using equation (1). Next, the row-wise dark offset D(x) is calculated for each row x using equation (6) (step 1330). The respective calculated dark offset D(x) is subtracted from the signals of each imaging pixel in area 20 in each row x (step 1340).

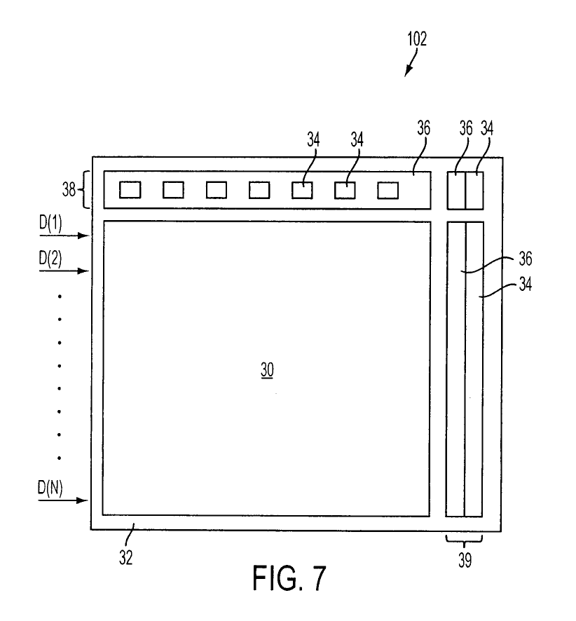

As an alternative embodiment, an imaging sensor may be constructed, as shown in FIG. 7, to include dark columns 39 containing pixel rows having both tied pixels in area 36 and optical black pixels in area 34 in the row. Although FIG. 7 shows the dark columns 39 as located on the right side of imaging area 30, the dark columns 39 can be placed in other locations, for example, the dark columns 39 could instead be located to the left of imaging area 30 or on both the right and left sides of imaging area 30. The illustrated embodiment of imaging sensor 102 contains imaging pixels in area 30 for imaging purposes. It should be appreciated that dark rows 38 may, but need not, be present in imaging sensor 102. The dark columns 39 include some number of columns of optical black pixels in area 34 and some number of columns of tied pixels in area 36 such that each row of the imaging pixel array includes one or preferably a plurality of optical black pixels in area 34 and one or preferably a plurality of tied pixels in area 36. To further shield the optical black pixels in area 34 in the dark columns 39 from light, the columns of tied pixels in area 36 may, but need not, be placed between the optical black pixels in area 34 and the imaging pixel array in area 30. During global shutter mode operation, instead of utilizing the dark rows 38 at the top or bottom of the pixel array, dark current compensation will be performed utilizing the dark columns 39. For a row n of imaging pixels in area 30, the row-wise dark offset D(n) will be calculated as the difference between the average of the optical black pixel signals in area 34 of row n and the average of the tied pixel signals in area 36 of row n according to:

D(n)=OB(n)_{avg}−T(n)_{avg} (7)

The calculated row-wise dark offset D(n) for the row n may then be subtracted from the signals of the optical imaging pixels in area 30 for the row n. This process may be repeated for each row n of imaging pixels in area 30.

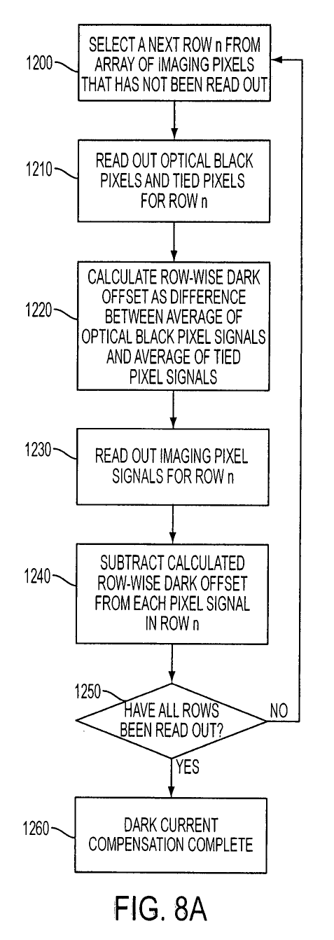

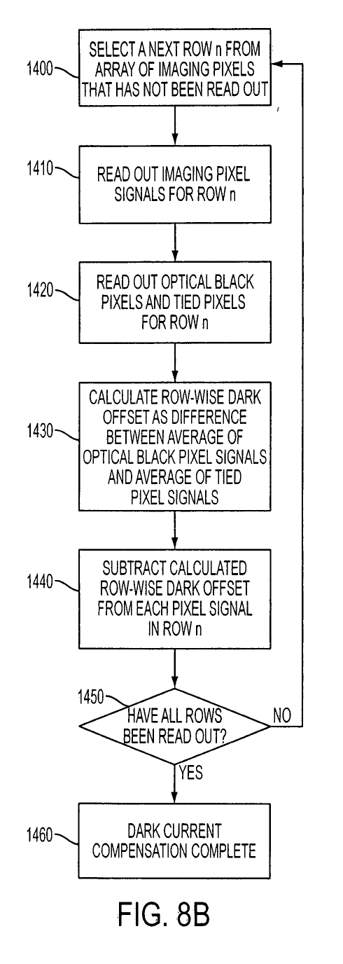

The flowchart of FIG. 8A illustrates a process for dark current compensation using dark columns 39, with tied pixels in area 36 and optical black pixels in area 34 in each row of FIG. 7. By subtracting the respective calculated row-wise dark offset from each imaging pixel signal in area 30 (FIG. 7) of the imaging sensor 102 (FIG. 7), a frame wide dark current compensation of imaging sensor 102 can be achieved. In step 1200, a next row n that has not been read out is selected from the array of imaging pixels in area 30. Signals from the optical black pixels in area 34 (FIG. 7) and the tied pixels in area 36 (FIG. 7) of the dark columns 39 (FIG. 7) are read out for the row n (step 1210). Then, the row-wise dark offset is calculated (step 1220) according to equation (7) for the row n. The signals from the imaging pixels in area 30 row n are then read out (step 1230). The calculated row-wise dark offset is subtracted from each imaging pixel in area 30 signal in row n (step 1240). If all rows have not been read out (step 1250), then steps 1200-1240 are repeated until all rows have been read out and dark current compensation is complete (step 1260).

The flowchart of FIG. 8B further illustrates another process for dark current compensation using dark columns 39, with tied pixels in area 36 and optical black pixels in area 34 in each row of FIG. 7. By subtracting the respective calculated row-wise dark offset from each imaging pixel signal in area 30 (FIG. 7) of the imaging sensor 102 (FIG. 7), a frame wide dark current compensation of imaging sensor 102 can be achieved. In step 1400, a next row n that has not been read out is selected from the array of imaging pixels in area 30. The signals from the imaging pixels in area 30 row n are read out (step 1410). In step 1420, signals from the optical black pixels in area 34 (FIG. 7) and the tied pixels in area 36 (FIG. 7) of the dark columns 39 (FIG. 7) are read out for row n. Then, the row-wise dark offset is calculated (step 1430) according to equation (7) for the row n. The calculated row-wise dark offset is subtracted from each imaging pixel in area 30 signal row n (step 1440). If all rows have not been read out (step 1450), then steps 1400-1440 are repeated until all rows have been read out and dark current compensation is complete (step 1460).

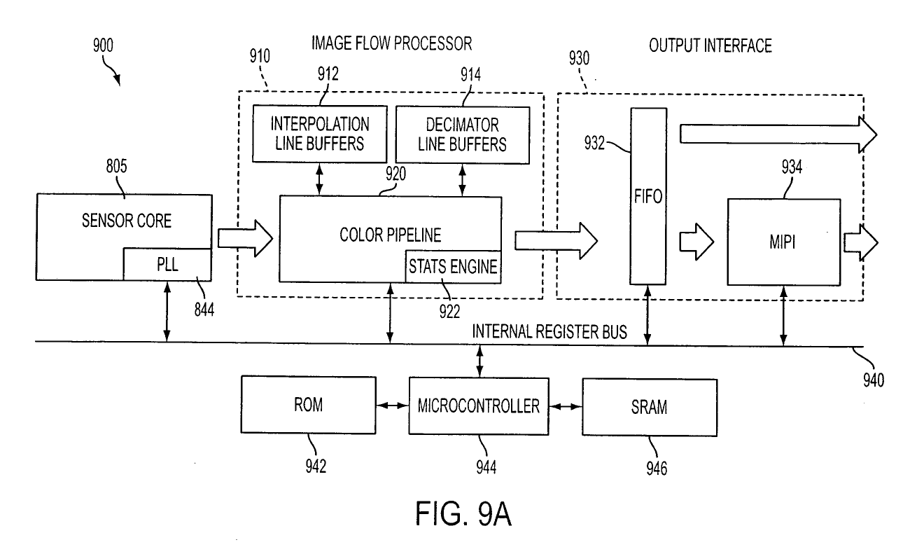

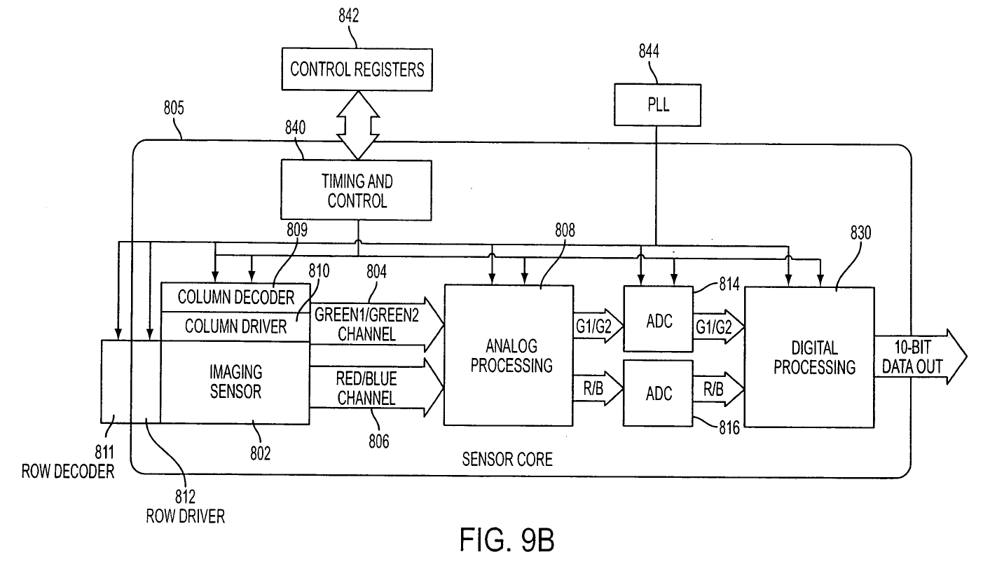

FIG. 9A illustrates a block diagram of an exemplary system-on-a-chip (SOC) imaging device 900 constructed in accordance with an embodiment. The imaging device 900 comprises a sensor core 805 that communicates with an image flow processor 910 that is also connected to an output interface 930. A phase locked loop (PLL) 844 is used as a clock for the sensor core 805. The image flow processor 910, which is responsible for image and color processing, includes interpolation line buffers 912, decimator line buffers 914, and a color pipeline 920. One of the functions of the color processor pipeline 920 is to perform pixel processing operations, such as, for example, dark current compensation in accordance with the disclosed embodiments. The color pipeline 920 includes, among other things, a statistics engine 922. The output interface 930 includes an output first-in-first-out (FIFO) parallel output 932 and a serial Mobile Industry Processing Interface (MIPI) output 934. The user can select either a serial output or a parallel output by setting registers within the chip. An internal register bus 940 connects read only memory (ROM) 942, a microcontroller 944 and a static random access memory (SRAM) 946 to the sensor core 805, image flow processor 910 and the output interface 930.

FIG. 9B illustrates a sensor core 805 used in the FIG. 9A imaging device 900. The sensor core 805 includes an imaging sensor 802, which is connected to analog processing circuitry 808 by a greenred/greenblue channel 804 and a red/blue channel 806. Although only two channels 804, 806 are illustrated, there are effectively two green channels, one red channel, and one blue channel, for a total of four channels. The greenred (i.e., Green1) and greenblue (i.e., Green2) signals are readout at different times (using channel 804) and the red and blue signals are readout at different times (using channel 806). The analog processing circuitry 808 outputs processed greenred/greenblue signals G1/G2 to a first analog-to-digital converter (ADC) 814 and processed red/blue signals R/B to a second analog-to-digital converter 816. The outputs of the two analog-to-digital converters 814, 816 are sent to a digital processor 830.

Connected to, or as part of, the imaging sensor 802 are row and column decoders 811, 809 and row and column driver circuitry 812, 810 that are controlled by a timing and control circuit 840. The timing and control circuit 840 uses control registers 842 to determine how the imaging sensor 802 and other components are controlled, for example, controlling the mode of operation of the imaging sensor 802 (e.g., global reset mode or electronic rolling shutter). As set forth above, the PLL 844 serves as a clock for the components in the core 805.

The imaging sensor 802 comprises a plurality of pixel circuits arranged in a predetermined number of columns and rows. Imaging sensor 802 may be configured with dark rows and dark columns in accordance with the embodiments described herein. In operation, the pixel circuits of each row in imaging sensor 802 are all turned on at the same time by a row select line and the pixel circuits of each column are selectively output onto column output lines by a column select line. A plurality of row and column lines are provided for the entire imaging sensor 802. The row lines are selectively activated by row driver circuitry 812 in response to the row address decoder 811 and the column select lines are selectively activated by a column driver 810 in response to the column address decoder 809. Thus, a row and column address is provided for each pixel circuit. The timing and control circuit 840 controls the address decoders 811, 809 for selecting the appropriate row and column lines for pixel readout, and the row and column driver circuitry 812, 810, which apply driving voltage to the drive transistors of the selected row and column lines.

Each column contains sampling capacitors and switches in the analog processing circuit 808 that read a pixel reset signal Vrst and a pixel image signal Vsig for selected pixel circuits. Because the core 805 uses greenred/greenblue channel 804 and a separate red/blue channel 806, circuitry 808 will have the capacity to store Vrst and Vsig signals for greenred, greenblue, red, and blue pixel signals. A differential signal (Vrst−Vsig) is produced by differential amplifiers contained in the circuitry 808 for each pixel. Thus, the signals G1/G2 and R/B are differential signals that are then digitized by a respective analog-to-digital converter 814, 816. The analog-to-digital converters 814, 816 supply digitized G1/G2, R/B pixel signals to the digital processor 830, which forms a digital image output (e.g., a 10-bit digital output). The digital processor 830 performs pixel processing operations. The output is sent to the image flow processor 910 (FIG. 9A).

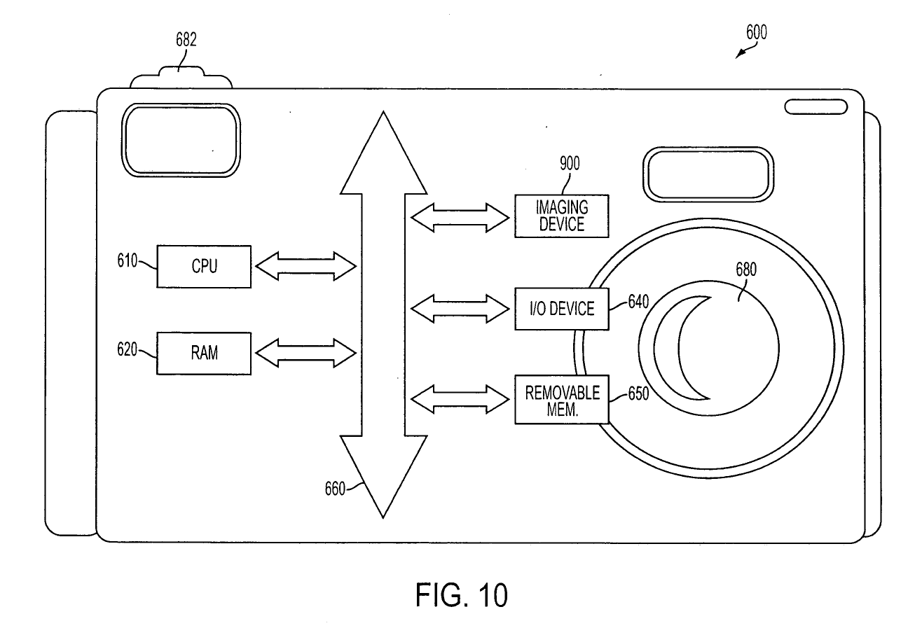

Although the sensor core 805 has been described with reference to use with a CMOS imaging sensor, this is merely one example sensor core that may be used. Embodiments of the invention may also be used with other sensor cores having a different readout architecture. While the imaging device 900 (FIG. 9A) has been shown as a system-on-a-chip, it should be appreciated that the embodiments are not so limited. Other imaging devices, such as, for example, a stand-alone sensor core 805 coupled to a separate signal processing chip could be used in accordance with the embodiments. While the dark current compensation has been described as occurring in the color processor pipeline 920 (FIG. 9A), it should be appreciated that dark current compensation can be performed in the digital processing 830 (FIB. 9B). Additionally, imaging, optical black, and tied pixel data from the imaging sensor 802 (FIG. 9B) can be output from the 10-bit data output (FIG. 9B) and stored and compensated elsewhere, for example, in a system as described in relation to FIG. 10 or in a stand-alone image processing system.

FIG. 10 shows a typical system 600, such as, for example, a camera. The system 600 is an example of a system having digital circuits that could include imaging devices 900. Without being limiting, such a system could include a computer system, camera system, scanner, machine vision, vehicle navigation system, video phone, surveillance system, auto focus system, star tracker system, motion detection system, image stabilization system, and other systems employing an imaging device 900.

System 600, for example, a camera system, includes a lens 680 for focusing an image on the imaging device 900 when a shutter release button 682 is pressed. System 600 generally comprises a central processing unit (CPU) 610, such as a microprocessor that controls camera functions and image flow, and communicates with an input/output (I/O) device 640 over a bus 660. The imaging device 900 also communicates with the CPU 610 over the bus 660. The system 600 also includes random access memory (RAM) 620, and can include removable memory 650, such as flash memory, which also communicates with the CPU 610 over the bus 660. The imaging device 900 may be combined with the CPU 610, with or without memory storage on a single integrated circuit, such as, for example, a system-on-a-chip, or on a different chip than the CPU 610. As described above, uncompensated data from the imaging sensor 802 (FIG. 9B) can be output from the imaging device 900 and stored, for example in the random access memory 620 or the CPU 610. Dark current compensation can then be performed on the stored data by the CPU 610, or can be sent outside the camera and stored and operated on by a stand-alone processor, e.g., a computer, external to system 600 in accordance with the embodiments described herein.

Some of the advantages of the dark current compensation methods disclosed herein include eliminating signal gradient for images captured by global reset mode, improving the image quality for imaging sensors designed for digital still cameras and digital single-lens reflex cameras, and improving imaging sensors' performance at higher operating temperatures. Additionally, the disclosed dark current compensation methods are simple to implement in existing imaging device designs.

While the embodiments have been described in detail in connection with preferred embodiments known at the time, it should be readily understood that the claimed invention is not limited to the disclosed embodiments. Rather, the embodiments can be modified to incorporate any number of variations, alterations, substitutions, or equivalent arrangements not heretofore described. For example, while the embodiments are described in connection with a CMOS imaging sensor, they can be practiced with other types of imaging sensors. Additionally, three or five channels, or any number of color channels may be used, rather than four, for example, and they may comprise additional or different colors/channels than greenred, red, blue, and greenblue, such as e.g., cyan, magenta, yellow (CMY); cyan, magenta, yellow, black (CMYK); or red, green, blue, indigo (RGBI).

1. A method of adjusting signals of imaging pixels of a pixel array, the method comprising:
determining a row-wise dark offset for the imaging pixels for more than one row of the pixel array using signals derived from tied pixels and optical black pixels of the array; a row-wise dark offset for at least one row being different from a row-wise dark offset for at least another row; and
applying the respective calculated row-wise dark offset to acquired imaging pixel signals of the corresponding rows of the array.

2. The method of claim 1, wherein the row-wise dark offset is determined for and applied to every row of the imaging pixels.

3. (canceled)

4. The method of claim 1, wherein the determined row-wise dark offset is applied to each acquired imaging pixel signal of the corresponding row of the array as the imaging pixel signal is acquired.

5. (canceled)

6. The method of claim 1, wherein the pixel array is configured such that the optical black pixels and tied pixels are arranged in dark rows above the imaging pixels.

7. The method of claim 6, wherein the step of determining the row-wise dark offset for a row of the array of imaging pixels is calculated according to:
D(n)=Dₜₒₜₐₗ+(n_{offset}+n)·D_{row}
where Dₜₒₜₐₗ represents a total dark offset calculated according to:
Dₜₒₜₐₗ=OB_{avg}−T_{avg}
where OB_{avg} is an average of the optical black pixel signals and T_{avg} is an average of the tied pixel signals; n represents a row number (e.g., n=1, 2, . . . , N) of the array of imaging pixels; n_{offset} represents a number of rows between a last dark row and a first row of the array of imaging pixels; and D_{row}, a dark offset caused by dark current during each row time t_{row} can be expressed as:
$${D}_{row} = \frac{{D}_{total}}{a}$$
where “a” is a constant.

8. The method of claim 1, wherein the pixel array is configured such that the optical black pixels and tied pixels are arranged in dark rows below the imaging pixels.

9. The method of claim 8, wherein the step of determining the row-wise dark offset for a row of the array of imaging pixels is calculated according to:
D(x)=Dₜₒₜₐₗ+(X_{offset}+X−x+1)·D_{row}
where Dₜₒₜₐₗ represents a total dark offset calculated according to:
Dₜₒₜₐₗ=OB_{avg}−T_{avg}
where OB_{avg} is an average of the optical black pixel signals and T_{avg} is an average of the tied pixel signals; x represents a row number (e.g., x=1, 2, . . . , X) of the array of imaging pixels; x_{offset} represents a number of rows between a last row of the array of imaging pixels and a first dark row; and D_{row}, a dark offset caused by dark current during each row time t_{row} can be expressed as:
$${D}_{row} = \frac{{D}_{total}}{a + {x}_{offset} + X}$$
where “a” is a constant.

10. The method of claim 1, wherein the pixel array is configured such that the optical black pixels and tied pixels are arranged in dark columns beside the imaging pixels, each row of imaging pixels comprising at least one optical black pixel and one tied pixel.

11. The method of claim 10, wherein the step of determining the row-wise dark offset for a row of the array of imaging pixels is calculated according to:
D(n)=OB(n)_{avg}−T(n)_{avg}
where OB(n)_{avg} is the average of the optical black pixel signals in row n and T(n)_{avg} is the average of the tied pixel signals in row n.

12. (canceled)

13. (canceled)

14. (canceled)

15. A method of adjusting signals of imaging pixels of a pixel array, the method comprising:
storing signals acquired from imaging pixels, optical black pixels, and tied pixels of the pixel array;
transmitting the stored data to a processor;
determining within the processor a row-wise dark offset for the imaging pixels for each row of the array using signals derived from the tied pixels and the optical black pixels; a row-wise dark offset for at least one row being different from a row-wise dark offset for at least another row; and
applying within the processor the respective calculated row-wise dark offset for each row to each acquired imaging pixel signal of a corresponding row of the array.

16. (canceled)

17. The method of claim 15, wherein the processor comprises an image processing pipeline.

18. A method of dark current adjustment for imaging pixels of a pixel array, the method comprising:
determining dark current adjustment values corresponding to each row of imaging pixels of the pixel array, the adjustment values being different for different rows of the array; and
adjusting the pixel signals of each row of the array with corresponding adjustment values for the row.

19. (canceled)

20. (canceled)

21. (canceled)

22. The method of claim 18, wherein the adjustment values are derived from signals from non-imaging pixels of the pixel array.

23. The method of claim 22, wherein the non-imaging pixels include optical black pixels and tied pixels.

24. The method of claim 23, wherein the optical black and tied pixels are located at at least one of a top side of the array near a first row of imaging pixels of the array, a bottom side of the array near a last row of imaging pixels of the array, a left side of imaging pixels of the array, and a right side of imaging pixels of the array.

25. (canceled)

26. (canceled)

27. An imaging device comprising:
an imaging sensor comprising an array of pixels which includes optical black pixels, tied pixels, and imaging pixels; and
a signal processing circuit for adjusting signals of rows of imaging pixels using signals derived from the tied pixels and the optical black pixels; a row-wise adjustment for at least one row being different from a row-wise adjustment for at least another row.

28. (canceled)

29. (canceled)

30. The imaging device of claim 27, wherein the signal processing circuit is configured to adjust signals by:
determining a row-wise dark offset for the imaging pixels for more than one row of the array using signals derived from the tied pixels and the optical black pixels; a row-wise dark offset for at least one row being different from a row-wise dark offset for at least another row; and
applying the respective calculated row-wise dark offset to acquired imaging pixel signals of the corresponding rows of the array.

31. (canceled)

32. (canceled)

33. (canceled)

34. The imaging device of claim 30, wherein the determined row-wise dark offset is applied to each acquired imaging pixel signal of the corresponding row of the array after the entire array of imaging pixels has been acquired.

35. The imaging device of claim 30, wherein the pixel array is configured such that the optical black pixels and tied pixels are arranged in dark rows above the imaging pixels.

36. The imaging device of claim 35, wherein the signal processing circuit is configured to determine the row-wise dark offset for a row of the array of imaging pixels according to:
D(n)=Dₜₒₜₐₗ+(n_{offset}n)·D_{row}
where Dₜₒₜₐₗ represents the total dark offset calculated according to:
Dₜₒₜₐₗ =OB_{avg} T_{avg}
where OB_{avg} is the average of the optical black pixel signals and T_{avg} is the average of the tied pixel signals; n represents the row number (e.g., n=1, 2, . . . , N) of the array of imaging pixels; n_{offset} represents the number of rows between the last dark row and the first row of the array of imaging pixels; and D_{row}, the dark offset caused by dark current during each row time t_{row} can be expressed as:
$${D}_{row} = \frac{{D}_{total}}{a}$$
where “a” is a constant.

37. The imaging device of claim 30, wherein the pixel array is configured such that the optical black pixels and tied pixels are arranged in dark rows below the imaging pixels.

38. The imaging device of claim 37, wherein the signal processing circuit is configured to determine the row-wise dark offset for a row of the array of imaging pixels according to:
D(x)=Dₜₒₜₐₗ+(x_{offset}+X−x+1)·D_{row}
where Dₜₒₜₐₗ represents the total dark offset calculated according to:
Dₜₒₜₐₗ =OB_{avg}−T_{avg}
where OB_{avg} is the average of the optical black pixel signals and T_{avg} is the average of the tied pixel signals; x represents the row number (e.g., x=1, 2, . . . , X) of the array of imaging pixels; x_{offset} represents the number of rows between the last row of the array of imaging pixels and a first dark row; and D_{row}, the dark offset caused by dark current during each row time t_{row} can be expressed as:
$${D}_{row} = \frac{{D}_{total}}{a + {x}_{offset} + X}$$
where 37 a” is a constant.

39. The imaging device of claim 27, wherein the signal processing circuit adjusts signals by:
determining a row-wise dark offset for the imaging pixels of a row of the pixel array using signals derived from dark columns of optical black pixels and tied pixels in the row, each row of imaging pixels further comprising at least one optical black pixel and one tied pixel; and
applying the respective calculated row-wise dark offset to acquired imaging pixel signals of the row of the array.

40. (canceled)

41. (canceled)

42. (canceled)

43. The imaging device of claim 39, wherein the signal processing circuit determines row-wise dark offset according to:
D(n)=OB(n)_{avg}−T(n)_{avg}
where OB(n)_{avg} is the average of the optical black pixel signals in row n and T(n)hd avg is the average of the tied pixel signals in row n.

44. An image processing system comprising:
a signal processing circuit for adjusting signals acquired from rows of imaging pixels in an array using signals derived from tied pixels and optical black pixels in the array; a row-wise adjustment for at least one row being different from a row-wise adjustment for at least another row.

45. (canceled)

46. (canceled)

47. (canceled)

48. (canceled)

49. (canceled)

50. (canceled)
